(19) United States
(12) Patent Application Publication
(10) Pub. No.: US 2009/0087695 A1
(43) Pub. Date: Apr. 2, 2009

(54) BIPOLAR PLATE FOR USE IN FUEL CELL STACKS AND FUEL CELL ASSEMBLIES

(75) Inventor: Kristian Silberbauer, Ribe (DK)

Correspondence Address: LOWRIE, LANDO & ANASTASI, LLP, ONE MAIN STREET, SUITE 1100, CAMBRIDGE, MA, 02142, US

(73) Assignee: AMERICAN POWER CONVERSION CORPORATION, W. Kingston, RI (US)

(21) Appl. No.: 11/866,294

(22) Filed: Oct. 2, 2007

(51) Int. Cl. H01M 8/10; H01M 16/00; H01M 8/02

(52) U.S. Cl. 429/9; 429/34; 429/35; 429/30; 29/623.1

(57) ABSTRACT

A fuel cell assembly comprising two similar bipolar plates with a first bipolar plate being aligned opposite to a second bipolar plate is provided. In certain examples, the second bipolar plate comprises a flow field in a substantially similar direction to a flow field of the first bipolar plate during operation of the fuel cell assembly.

### FIELD OF THE TECHNOLOGY

Embodiments of the technology disclosed herein relate generally to fuel cells and to bipolar plates for use in fuel cell assemblies. More particularly, certain examples disclosed herein are directed to adjacent bipolar plates that are aligned substantially opposite to each other.

### BACKGROUND

Most fuel cell stacks use two bipolar plates per electrolyte-electrode assembly (EEA). The bipolar plates transport reactants and products to and from the fuel cells. In some fuel cells with a single bipolar plate per electrolyte-electrode assembly, adjacent plates are rotated ninety degrees from each other and form a system of channels to supply reactants to the fuel cells.

### SUMMARY

In accordance with a first aspect, a fuel cell assembly is disclosed. In certain examples, the fuel cell assembly comprises a first bipolar plate and a second bipolar plate substantially similar to the first bipolar plate. In some examples, the second bipolar plate comprises a cathodic flow field in a substantially similar direction to a cathodic flow field of the first bipolar plate with the second plate aligned substantially opposite to the first plate, e.g., rotated 180 degrees. In certain examples, the fuel cell assembly may further comprise at least one manifold fluidically coupled to the first and second bipolar plates and configured to provide reactants to the first and second bipolar plates. In some examples, the fuel cell assembly may also include at least one electrolyte-electrode assembly between the first bipolar plate and the second bipolar plate.

In certain examples, the fuel cell assembly may further comprise a first gasket between the first bipolar plate and the electrolyte-electrode assembly and a second gasket between the second bipolar plate and the electrolyte-electrode assembly. In some examples, the first gasket and the second gasket may be substantially similar. In certain examples, the first bipolar plate and the second bipolar plate may be constructed and arranged to have a substantially similar aperture arrangement. In other examples, the electrolyte-electrode assembly comprises a polymer electrolyte membrane between an anode and a cathode. In certain examples, the first bipolar plate, the second bipolar plate and the electrolyte-electrode assembly may be constructed and arranged to provide a direct methanol fuel cell. In some examples, the first bipolar plate comprises a plurality of apertures and the second bipolar plates comprises a plurality of apertures, and in which a first aperture in the first bipolar plate is aligned substantially opposite to a first aperture in the second bipolar plate. In certain examples, at least one additional manifold may be fluidically coupled to the first bipolar plate and the second bipolar plate.

In accordance with another aspect, a fuel cell assembly comprising a plurality of substantially similar bipolar plates and plurality of electrolyte-electrode assemblies is provided. In certain examples, at least one of the electrolyte-electrode assemblies may be between two of the plurality of the substantially similar bipolar plates. In some examples, each of the electrolyte-electrode assemblies comprises a cathode, an anode and an electrolyte between the cathode and the anode. In certain examples, adjacent bipolar plates may be constructed and arranged to be aligned substantially opposite to each other to provide cathodic and anodic flow fields having substantially similar directions.

In certain examples, each of the bipolar plates may comprise an anterior cathodic flow field, a posterior anodic flow field and a plurality of apertures coupled to the flow fields and to the apertures of the adjacent bipolar plates. In some examples, the electrolyte may be a polymer electrolyte membrane. In certain examples, each of the electrolyte-electrode assemblies is configured to provide a direct methanol fuel cell. In some examples, the fuel cell assembly may further comprise a manifold fluidically coupled to at least two of the plurality of substantially similar bipolar plates. In certain examples, the manifold may be configured to provide fuel, air or both fuel and air to the bipolar plates.

In accordance with an additional aspect, a power distribution system for a load is disclosed. In certain examples, the system comprises a fuel cell assembly comprising a fuel cell stack and at least two adjacent bipolar plates coupled to the fuel cell stack. In some examples, the two adjacent bipolar plates may be constructed and arranged to provide cathodic and anodic flow fields in a substantially opposite direction. In certain examples, a controller may be electrically coupled to the fuel cell assembly and configured to selectively couple the fuel cell assembly to a load.

In certain examples, the system may further comprise at least one battery electrically coupled to the controller. In other examples, the controller may be configured to switch the fuel cell assembly on when a power loss is detected by the controller.

In accordance with another aspect, a method of assembling a fuel cell stack is provided. In certain examples, the method comprises assembling the fuel cell stack by placing an electrolyte-electrode assembly between a first bipolar plate and a second bipolar plate. In some examples, the first and second bipolar plates may be constructed and arranged to be aligned substantially opposite to each other and provide an anode flow field in the first bipolar plate that is in a substantially opposite direction to a cathode flow field in the second bipolar plate during operation of the fuel cell stack.

In certain examples, the method may also comprise assembling the fuel cell stack by placing a first gasket between the first bipolar plate and the electrolyte-electrode assembly and placing a second gasket between the second bipolar plate and the electrolyte-electrode assembly. In some examples, the fuel cell stack may be configured as a direct methanol fuel cell stack. In certain examples, the method may also include providing air to the cathode side of the first bipolar plate and fuel to the anode side of the second bipolar plate without using openings in a side of the first and second bipolar plates.

In accordance with an additional aspect, a fuel cell assembly comprising a first bipolar plate fluidically coupled to a second bipolar plate is disclosed. In certain examples, the first bipolar plate comprises a cathodic flow field and an anodic flow field. In some examples, the second bipolar plate comprises a cathodic flow field and an anodic flow field with the cathodic flow field of the second bipolar plate being in a substantially similar direction as the direction of the cathodic flow field of the first bipolar plate.

Additional features, aspects and examples are described in more detail below.

### BRIEF DESCRIPTION OF THE FIGURES

Certain embodiments are described below with reference to the accompanying figures in which:

FIG. 1 is a schematic of an electrolyte-electrode assembly, in accordance with certain examples;

FIG. 2 is a fuel cell stack showing flow fields for a first bipolar plate and flow fields for a second bipolar plate, in accordance with certain examples;

FIG. 3 shows an illustrative example of a bipolar plate, in accordance with certain examples;

FIG. 4 shows two bipolar plates that are substantially the same, in accordance with certain examples;

FIG. 5 shows a fuel cell assembly comprising a manifold, in accordance with certain examples;

FIG. 6 shows a bipolar plate comprising a gasket, in accordance with certain examples;

FIG. 7 shows two bipolar plates each comprising a single type of gasket and each being substantially the same as the other bipolar plate, in accordance with certain examples;

FIG. 8 shows a fuel cell assembly comprising a plurality of membrane electrode assemblies and a plurality of bipolar plates, in accordance with certain examples; and

FIG. 9 shows a power system, in accordance with certain examples.

Certain features shown in the figures may have been enlarged, distorted, altered or otherwise shown in a non-conventional manner to facilitate a better understanding of the technology disclosed herein. Reference to the terms “top,” “bottom,” “side,” and the like are for convenience purposes only and the devices disclosed herein may be used or positioned in any orientation.

### DETAILED DESCRIPTION

Certain embodiments of the devices and methods disclosed herein provide significant advantages to fuel cell assemblies including, but not limited to, design simplification, cost reduction, size reduction and/or improved performance. In certain embodiments where the bipolar plates are mounted or aligned substantially opposite to each other several advantages may be achieved including, but not limited to, providing a flow that does not go against gravity, adjacent openings are configured similarly, e.g., air-in lies next to air-in such that external connection of manifold is simplified, manifolds on the side may be omitted to provide for increased space for membrane-electrode assemblies to increase the membrane-electrode surface area, and/or there is no need for a square membrane-electrode assembly. Additional advantages of the examples and embodiments disclosed herein will be recognized by the person of ordinary skill in the art, given the benefit of this disclosure.

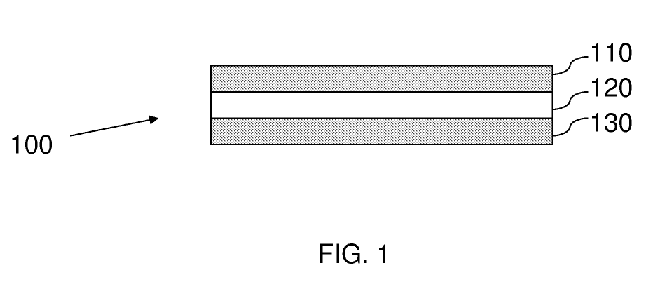

In accordance with certain examples, a typical fuel cell stack comprises a plurality of electrolyte-electrode assemblies (EEAs). A typical EEA includes an electrolyte between two or more conductors—one acting as a cathode and the other acting as an anode. For example and referring to FIG. 1, an electrolyte-electrode assembly 100 comprises a cathode 110, an anode 130, and an electrolyte 120 between the cathode 110 and the anode 130.

In accordance with certain examples, a particular example of an EEA comprises a polymer electrolyte membrane. These configurations are often referred to as membrane electrode assemblies (MEAs). Fuel cells that contain one or more MEAs include, but are not limited to, microbial fuel cells and proton exchange membrane fuel cells such as direct methanol fuel cells, reformed methanol fuel cells, direct ethanol fuel cells, and formic acid fuel cells. A fuel source may be provided to the anode of the MEA, and the fuel may be split into protons and electrons. The protons may migrate through the electrolyte membrane to the cathode. The electrons produced at the anode may migrate to the cathode through a circuit connecting the anode and the cathode where they recombine with the electrons and oxygen to form water. An electrical device may be placed between the anode and the cathode, and the migrating electrons may be used to power the electrical device.

In accordance with certain examples, each electrolyte-electrode assembly may use two bipolar plates. As used herein, bipolar plates may be used interchangeably in some instances with the terms “separator plates” and “flow field plates.” The bipolar plates provide air and fuel to the MEA and may provide air or other coolant to cool the MEA. In many existing fuel cell configurations, two different bipolar plates may be sandwiched together to create fuel and air transfer cavities. Several ways have been attempted to avoid using two different bipolar plates. WO2005/086273A1 discloses a dual function bipolar plate. The bipolar plate has a cathodic flow field and an anodic flow field in a single plate. The manifolds consists of a pattern of orifices and reverse side seals that area located on each edge of the bipolar separator plate so that a second bipolar plate may be aligned at a 90 degree angle with respect to the first orifice/reverse side seal.

Certain examples disclosed herein describe a bipolar plate that provides fluids for both a cathode and an anode. Embodiments of the bipolar plates disclosed herein thus provide a cathodic flow field and an anodic flow field. These flow fields are on opposite sides of the bipolar plate and are referred to in certain instances herein for convenience purposes as anterior cathodic flow field and posterior anodic flow field.

In certain embodiments disclosed herein, two bipolar plates may each be constructed and arranged such that the plates may be aligned substantially opposite to each other, e.g., at a 180 degree angle with respect to a first orifice. In certain examples, adjacent bipolar plates may be configured such that the bipolar plates are constructed and arranged to be exactly the same with the direction of a flow field of one plate being the same as the direction of a field flow of an adjacent plate, such that the cathodic flow field of a first bipolar plate is the same as the cathodic flow field of a second bipolar plate, but the plates rotated 180°. This configuration differs from a conventional fuel cell stack arrangement and the arrangement disclosed in WO 2005/086273A1 where the cathode flow fields and anode flow fields of adjacent plates are each perpendicular to each other. In certain examples, the bipolar plates may also function as, or include, current collectors.

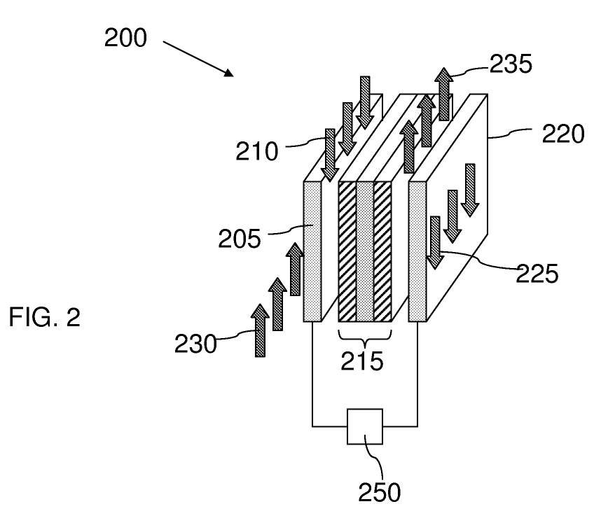

In accordance with certain examples, an illustration of a fuel cell stack showing the flow fields of adjacent bipolar plates is shown in FIG. 2. The fuel cell stack 200 comprises a first bipolar plate 205, a second bipolar plate 220, and an electrolyte-electrode assembly 215 between the first bipolar plate 205 and the second bipolar plate 220. The first bipolar plate 205 and the second bipolar plate 220 are shown coupled to a load 250. A cathodic flow field 210 of the first bipolar plate 205 is shown as being parallel to the planar surfaces of the electrolyte-electrode assembly 215. A cathodic flow field 225 of a second bipolar plate 220 is shown as also being parallel to the planar surfaces of the electrolyte-electrode assembly 215, with the direction of the cathodic flow field 225 of the second bipolar plate being substantially similar to that of the cathodic field flow 210 of the first bipolar plate 205. Similarly, the first bipolar plate 205 also comprises an anodic flow field 230 that flows in a direction that is substantially similar to the anodic flow field 235 of the second bipolar plate 220. The degree to which the flow fields may be substantially similar may vary and preferably the flow fields have directions which are substantially parallel and in the same direction. In certain instances herein, these field flows are referred to as being parallel with the direction of flow being substantially similar to each other.

In accordance with certain examples, the flow fields 210 and 225 (and flow fields 230 and 235) may be produced by constructing apertures or openings along the edges of the bipolar plates 205 and 220. These apertures may be constructed and arranged to contact the surfaces of the electrodes to provide fuel, air or both fuel and air to the electrode-electrolyte assembly. In one embodiment, a first aperture in adjacent bipolar plates may be aligned substantially opposite to each other, whereas in other single plate fuel cell assemblies, the apertures would be perpendicular to each other. By arranging the apertures to be substantially opposite to each other, side manifolds may be omitted. This arrangement provides for a larger active electrolyte-electrode area relative to the fuel cell stack volume, which can increase the overall performance of the fuel cell stack.

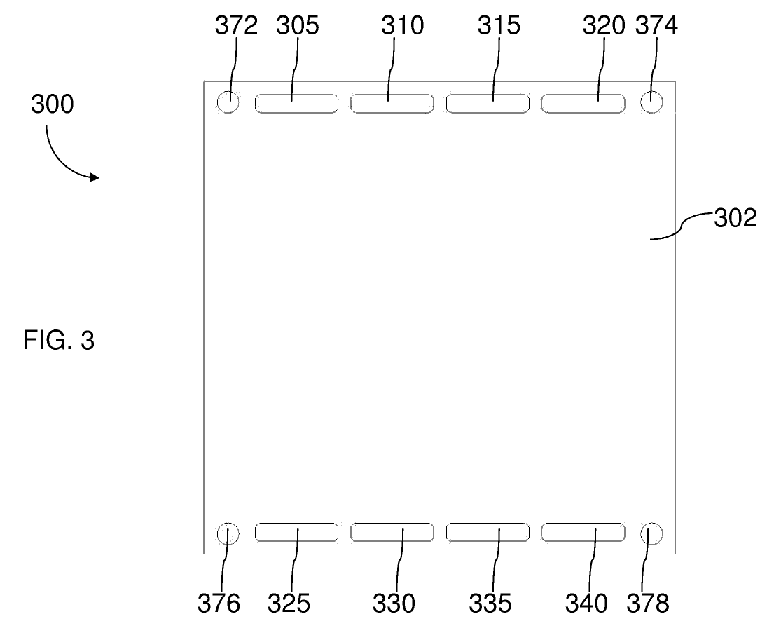

In accordance with certain examples, a side view of a bipolar plate is shown in FIG. 3. The bipolar plate 300 comprises a body 302 with a plurality of apertures in the body. The apertures may be configured to introduce fuel, air or both fuel and air to the electrolyte-electrode assembly. For example, the bipolar plate 300 comprises a first aperture 305, a second aperture 310, a third aperture 315 and a fourth aperture 320 positioned along one edge of the body 302 of the bipolar plate 300. On an opposite edge of the body 302 of the bipolar plate 300 is a fifth aperture 325, a sixth aperture 330, a seventh aperture 335 and an eighth aperture 340. The bipolar plate 300 also includes openings 372, 374, 376 and 378 configured to receive a fixation rod (not shown). As shown in FIG. 3, apertures 305, 310, 315, 320, 325, 330, 335 and 340 are configured to have substantially the same shape. In one embodiment where the manifolds for fuel and air desirably have different shapes, apertures for fuel 305, 310, 335 and 340 may be similar, and apertures for air 315, 320, 325 and 330 may be similar. Apertures 305 and 310 are cathode in apertures, apertures 335 and 340 are cathode out apertures, apertures 315 and 320 are anode out apertures, and apertures 325 and 330 are anode in apertures.

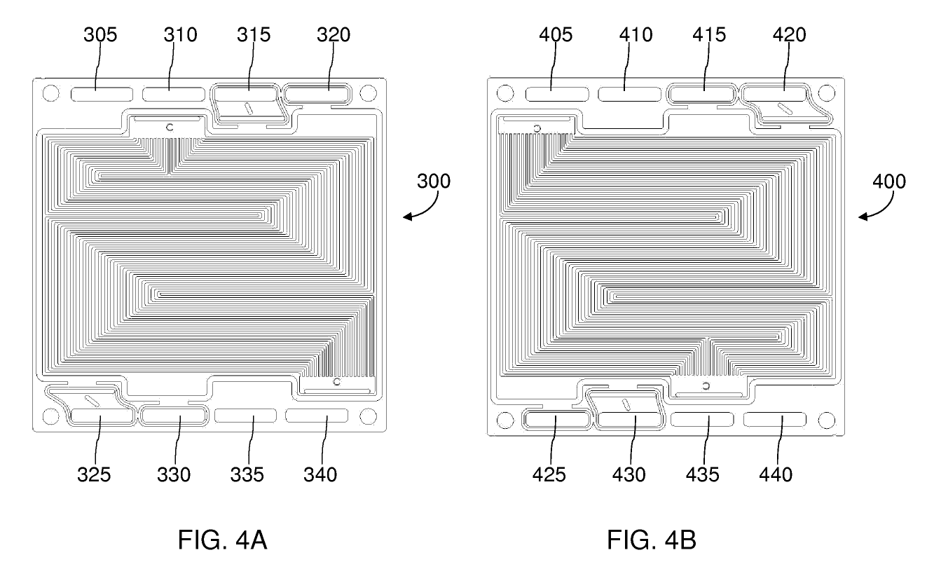

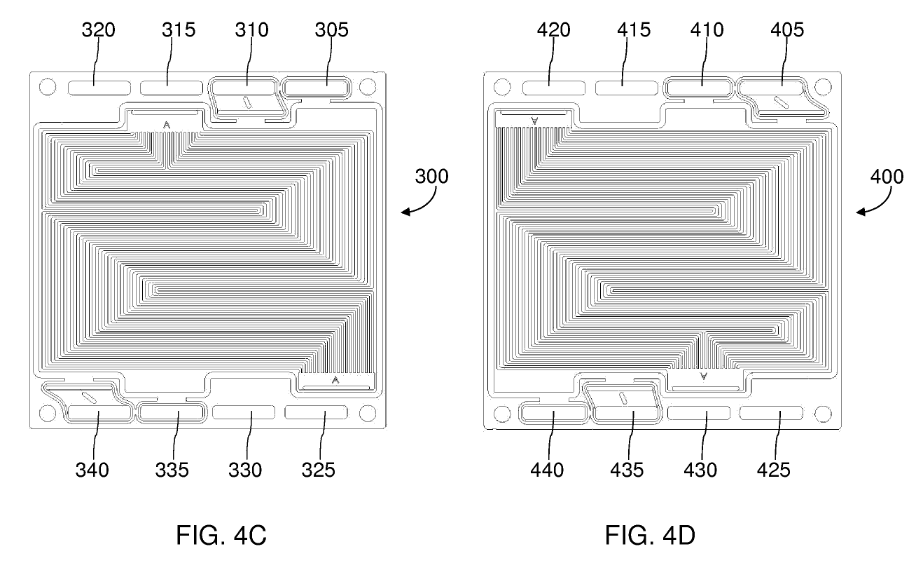

In accordance with certain examples, a fuel cell stack may be assembled using two similar bipolar plates. Referring to FIGS. 4A and 4B, two bipolar plates 300 and 400 are shown. First bipolar plate 300 comprises eight apertures 305, 310, 315, 320, 325, 330, 335 and 340. Second bipolar plate 400 also comprises eight apertures 405, 410, 415, 420, 425, 430, 435 and 440. FIG. 4A and FIG. 4B shows the cathode side of two adjacent bipolar plates, where plate 400 is rotated 180° (turned up side down) relative to plate 300. The apertures of plate 300 and plate 400 are structurally similar in the following way: 305 is similar to 440, 310 is similar to 435, 315 is similar to 430, 320 is similar to 425, 325 is similar to 420, 330 is similar to 415, 335 is similar to 410, 340 is similar to 405. In an assembled fuel cell stack where bipolar plate 300 is at the top of a fuel cell stack and bipolar plate 400 is at the bottom of a fuel cell stack, aperture 305 may be fluidically coupled to aperture 405. As used herein “fluidically coupled” refers to the case where two or more devices (or a portion thereof) are connected in a suitable manner such that a fluid, e.g., liquid, gas, supercritical fluid or the like, may flow between the devices (or a portion thereof). Aperture 310 may be fluidically coupled to aperture 410, aperture 315 may be fluidically coupled to aperture 415, aperture 320 may be fluidically coupled to aperture 420, aperture 325 may be fluidically coupled to aperture 425, aperture 330 may be fluidically coupled to aperture 430, aperture 335 may be fluidically coupled to aperture 435 and aperture 340 may be fluidically coupled to aperture 440. This configuration of the bipolar plates may provide several advantages including, but not limited to, a larger usable area in or near the sides of the electrolyte-electrode assembly, movement of bubbles upward and movement of water downwards, and permits the entrances/exits of the apertures to meet in pairs. When the bipolar plates 300 and 400 are aligned substantially opposite to each other, aperture 305 is aligned substantially opposite to aperture 440, e.g., rotated about 180 degrees from each other in the fuel cell assembly.

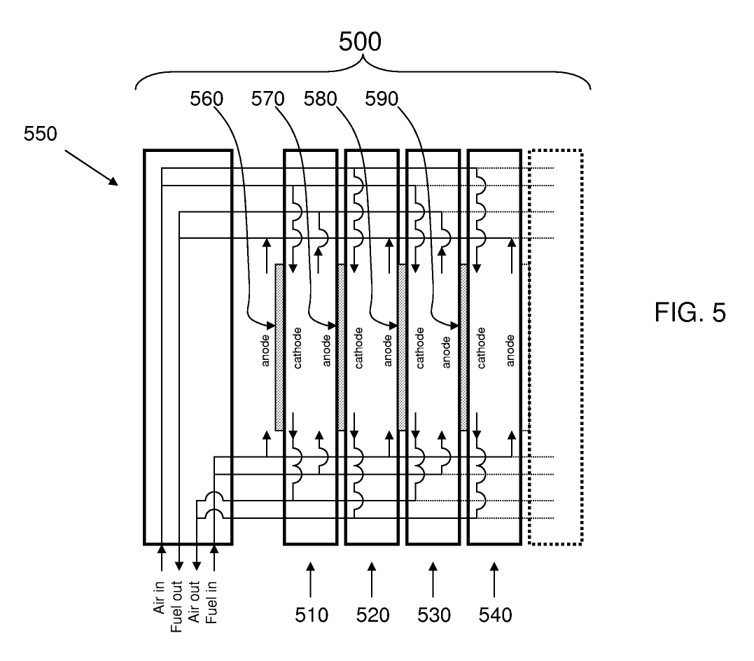

In accordance with certain examples, each of the apertures shown in the bipolar plates 300 and 400 may be fluidically coupled to a manifold to introduce fuel into certain apertures and air into other apertures. An illustration of this configuration is shown as a side view in FIG. 5. The fuel cell assembly 500 comprises four bipolar plates 510, 520, 530 and 540, a manifold 550 fluidically coupled to the four bipolar plates 510, 520, 530 and 540, a fuel cell electrolyte-electrode assembly 560 between the manifold 550 and the bipolar plate 510, a fuel cell electrolyte-electrode assembly 570 between the two bipolar plates 510 and 520, a fuel cell electrolyte-electrode assembly 580 between the two bipolar plates 520 and 530, and a fuel cell electrolyte-electrode assembly 590 between the two bipolar plates 530 and 540. The fuel cell assembly 500 may also include an additional manifold. In a typical configuration, the fuel cell assembly comprises an air manifold or cathode manifold to provide air to the cathodes and also includes a fuel manifold or an anode manifold to provide fuel to the anodes. The fuel cell assembly may also include one or more exhaust manifolds, such as an air outlet manifold and a fuel or exhaust outlet manifold. In some examples, the bipolar plates disclosed herein may be used with the manifold type described in commonly assigned patent application bearing U.S. Ser. No. 11/752,416 and entitled “MANIFOLD FOR FUEL CELLS,” the entire disclosure of which is hereby incorporated herein by reference for all purposes. It will be within the ability of the person of ordinary skill in the art, given the benefit of this disclosure, to assemble suitable fuel cell assemblies using the bipolar plates disclosed herein.

In accordance with certain examples, the exact number of apertures and their arrangement in the bipolar plate may vary. While eight manifold apertures are shown in the illustrations of FIGS. 3, 4A and 4B, it will be recognized by the person of ordinary skill in the art, given the benefit of this disclosure that fewer or more manifold apertures may be present. In certain examples, at least 2 apertures are present in the bipolar plate, more particularly at least 3, 4, 5, 6, 7, 8, 9, 10, 11 or 12 manifold apertures may be present in the bipolar plate. The exact placement of the apertures in the bipolar plates may also vary. In particular, the apertures may be placed anywhere in the bipolar plate provided that an aperture in one bipolar plate may be fluidically coupled to an aperture in an adjacent bipolar plate. In some examples, the apertures may be positioned along one or more edges of the bipolar plate. Similarly, the exact cross-sectional shape of the apertures may vary, and illustrative shapes include but are not limited to, rectangular, square, circular, elliptical, triangular and other suitable shapes that will be readily selected by the person of ordinary skill in the art, given the benefit of this disclosure.

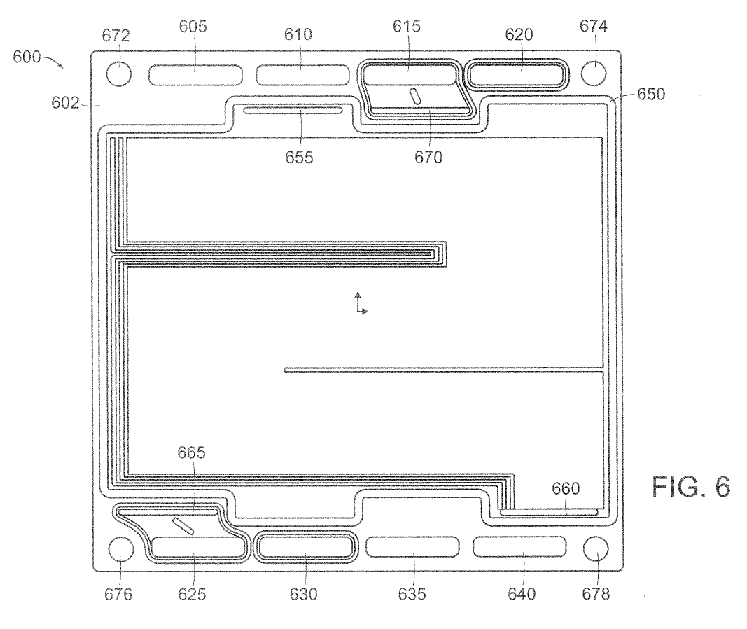

In accordance with certain examples, one or more bipolar plates comprising a gasket may be used to assemble a fuel cell stack. In certain examples, the gasket may provide a seal to reduce or prevent leakage of fuel and/or air from the fuel cell stack or fuel cell assembly. Referring to FIG. 6, a bipolar plate 600 comprises a body 602 with a gasket 650 disposed on the body 602. The bipolar plate 600 also comprises a first aperture 605, a second aperture 610, a third aperture 615 and a fourth aperture 620 on one side of the bipolar plate 600. The bipolar plate 600 also comprises a fifth aperture 625, a sixth aperture 630, a seventh aperture 635 and an eighth aperture 640. The bipolar plate 600 also includes apertures 672, 674, 676 and 678 configured to receive a fixation rod (not shown). As shown in FIG. 6, apertures 605, 610, 635 and 640 are configured to have substantially the same shape. Apertures 615 and 625 are also configured to have substantially the same shape. Apertures 620 and 630 are also configured to have substantially the same shape. The body 602 comprises four apertures 655, 660, 665 and 670. Aperture 655 is fluidically coupled to aperture 610, aperture 660 is fluidically coupled to aperture 640, aperture 665 is fluidically coupled to aperture 625, and aperture 670 is fluidically coupled to aperture 615.

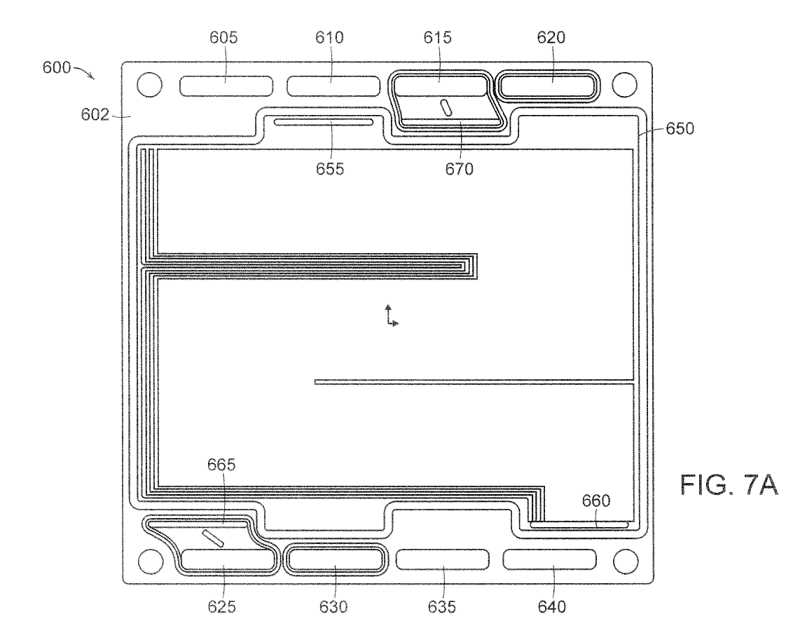

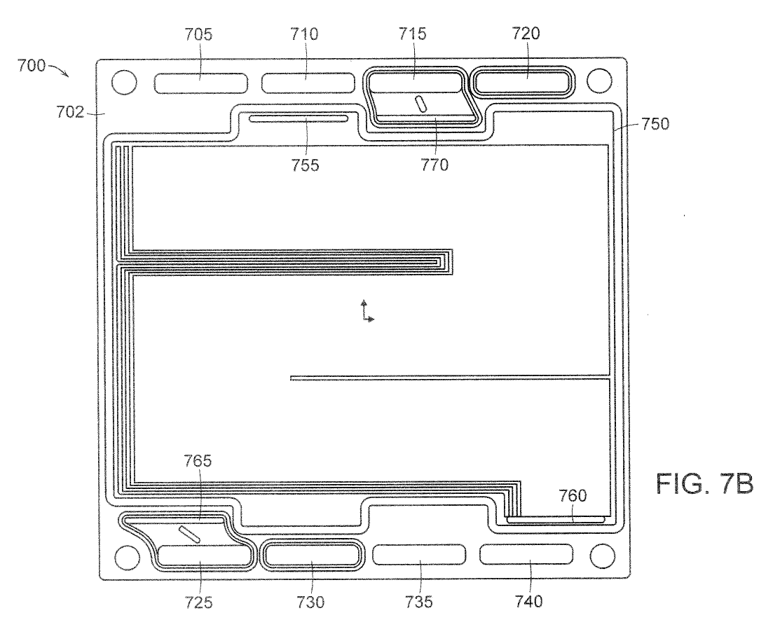

In accordance with certain examples, a fuel cell stack may be assembled using two of the bipolar plates shown in FIG. 6. Referring to FIGS. 7A and 7B, two bipolar plates 600 and 700 are shown. A first bipolar plate 600 comprises eight apertures 605, 610, 615, 620, 625, 630, 635 and 640. The first bipolar plate 600 also comprises a gasket 650, a body 602 and apertures 655, 660, 665 and 670. A second bipolar plate 700 also comprises eight apertures 705, 710, 715, 720, 725, 730, 735 and 740. The second bipolar plate also comprises a gasket 750, a body 702 and apertures 755, 760, 765 and 770. In an assembled fuel cell stack where bipolar plate 600 is at the top of a fuel cell stack and bipolar plate 700 is at the bottom of a fuel cell stack, apertures 605 may be fluidically coupled to aperture 725. Apertures 610 may be fluidically coupled to aperture 730, aperture 615 may be fluidically coupled to aperture 735, aperture 620 may be fluidically coupled to aperture 740, aperture 625 may be fluidically coupled to aperture 705, aperture 630 may be fluidically coupled to aperture 710, aperture 635 may be fluidically coupled to aperture 715 and aperture 640 may be fluidically coupled to aperture 720. As discussed above, this configuration of the bipolar plates may provide several advantages including, but not limited to, a larger usable area in or near the sides of the electrolyte-electrode assembly, movement of bubbles upward and movement of water downwards, and permits the entrances/exits of the apertures to meet in pairs.

In accordance with certain examples, each of the apertures shown in the bipolar plates 600 and 700 may be fluidically coupled to a manifold to introduce fuel into certain apertures and air into other apertures. In a typical configuration, the fuel cell assembly comprises an air manifold or cathode manifold to provide air to the cathodes and also includes a fuel manifold or an anode manifold to provide fuel to the anodes. The fuel cell assembly may also include one or more exhaust manifolds, such as an air outlet manifold and a fuel or exhaust outlet manifold. In some examples, the bipolar plates disclosed herein may be used with the manifold described in commonly assigned patent application bearing U.S. Ser. No. 11/752,416 and entitled “MANIFOLD FOR FUEL CELLS.” It will be within the ability of the person of ordinary skill in the art, given the benefit of this disclosure, to assemble suitable fuel cell assemblies using the bipolar plates disclosed herein.

In accordance with certain examples, the exact number of apertures and their arrangement in a bipolar plate comprising a gasket may vary. While eight apertures are shown in the illustrations of FIGS. 6, 7A and 7B, it will be recognized by the person of ordinary skill in the art, given the benefit of this disclosure that fewer or more apertures may be present. In certain examples, at least 2 apertures are present in the bipolar plate, more particularly at least 3, 4, 5, 6, 7, 8, 9, 10, 11 or 12 manifold apertures may be present in the bipolar plate. The exact placement of the apertures in the bipolar plates and in the gaskets may also vary. In particular, the apertures may be placed anywhere in the bipolar plate or the gasket provided that an aperture in one bipolar plate may be fluidically coupled to an aperture in an adjacent bipolar plate. Similarly, the exact cross-sectional shape of the apertures in a bipolar plate comprising a gasket may vary, and illustrative shapes include but are not limited to, rectangular, square, circular, elliptical, triangular and other suitable shapes that will be readily selected by the person of ordinary skill in the art, given the benefit of this disclosure.

In accordance with certain examples, the materials used to manufacture the bipolar plates may vary. In certain examples, the bipolar plates may include non-metals such as graphite or metals, such as certain grades of steel or surface treated metals, or from electrically conductive plastic composite materials, or from ceramic compositions. Additional suitable materials for manufacturing the bipolar plate include, but are not limited to, silicium and conductive ceramics. The apertures in the bipolar plates may be provided between the bipolar plate and the adjacent electrode to provide fuel or air to the electrodes and removal of products. The apertures may be machined, etched, cut or otherwise formed in one or more surfaces of the bipolar plate. In certain examples, the apertures may be formed by casting or pressing of a graphite powder composite.

In accordance with certain examples, the gasket used in certain embodiments disclosed herein may be manufactured from many different materials including, but not limited to, plastics, elastomers, non-metals such as graphite, silicon, and the like. In some examples, the gasket may be made from silicone. In certain examples, the gasket may be flexible or resilient such that it may be stretched or contracted.

In accordance with certain examples, the fuel cell stacks and assemblies disclosed herein may include additional features or devices between the bipolar plates and the fuel cell assemblies. In certain examples, one or more spacers may be placed between the bipolar plate and the fuel cell stack. In other examples, one or more backing layers may be placed between the bipolar plate and the fuel cell stack.

In accordance with certain examples, the bipolar plates disclosed herein may function as or include a current collector. Electrons produced by the oxidation of a fuel must migrate from the anode, through a backing layer (if present), along the length of the fuel cell stack, and through the bipolar plate. The electrons may then exit the fuel cell assembly and migrate through an external circuit. The electrons may re-enter the fuel cell assembly through the bipolar plate at the cathode. If a load-containing external circuit, such as an electric motor, is present, the electric current will flow from the anode to the cathode and may be used to power the load.

In accordance with certain examples, a compression mechanism may be used to hold the bipolar plates together with the fuel cell stacks to provide a fuel cell assembly. The compression mechanism may take numerous forms and typically includes one or more fixation rods inserted into the apertures of the bipolar plates (see, for example, opening 672, 674, 676 and 678 in FIG. 6). One or more fasteners, such as a nut, may be threaded onto the ends of the fixation rods to compress the bipolar plates and fuel cell stacks to a desired force or torque.

In accordance with certain examples, the exact type of fuel cell stacks that may be used with the bipolar plates disclosed herein may vary. In certain examples, fuel cells that may be configured to introduce fuel into the fuel cell stack at a lower temperature than the stack operating temperature may be used. For example, introduction of fuel into direct methanol and direct ethanol fuel cells may function to cool the fuel cell stack. Proton exchange membrane fuel cells may be used with the bipolar plates disclosed herein. A proton exchange membrane fuel cell includes a proton exchange membrane between an anode and a cathode. Protons migrate from the anode to the cathode where they react with oxygen and electrons produced at the anode to form water. A direct methanol fuel cell stack uses a proton exchange membrane between the cathode and the anode, uses methanol as a fuel and converts the methanol into carbon dioxide and water. A direct ethanol fuel cell stack uses a proton exchange membrane between the cathode and the anode, uses ethanol as a fuel and converts the ethanol into carbon dioxide and water. A formic acid fuel cell stack uses a proton exchange membrane between the cathode and the anode, uses formic acid as the fuel and converts the formic acid into carbon dioxide and water.

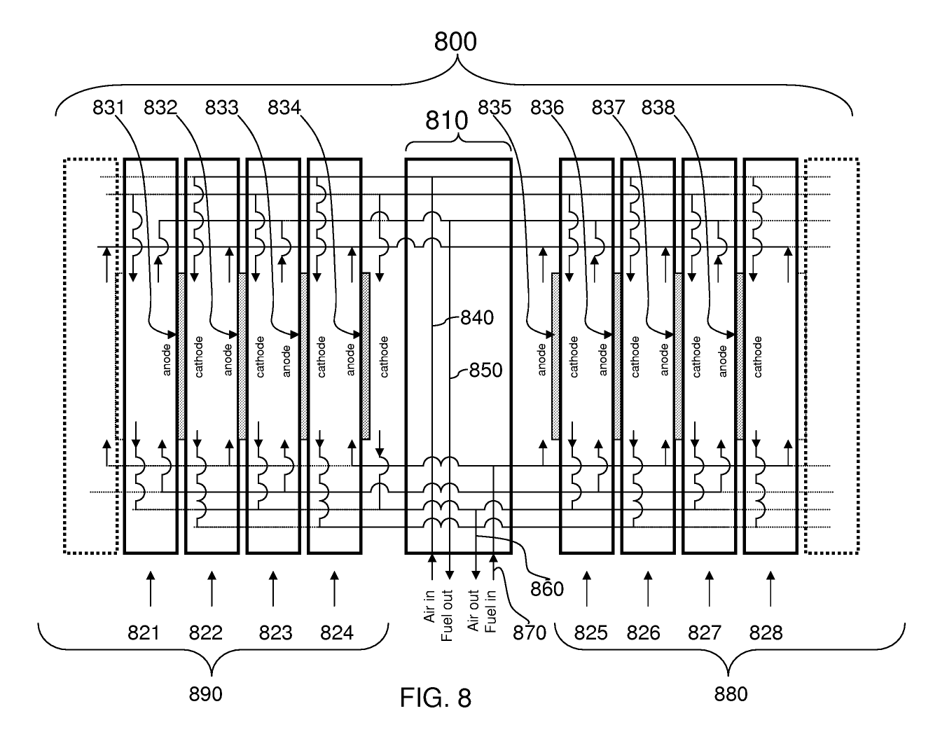

In accordance with certain examples, the bipolar plates disclosed herein may be used in a fuel cell assembly comprising a plurality of substantially similar bipolar plates and plurality of electrolyte-electrode assemblies. In some examples, at least one of the electrolyte-electrode assemblies is between two of the bipolar plates. In certain examples, each of the electrolyte-electrode assemblies comprises a cathode, an anode and an electrolyte between the cathode and the anode. In some examples, the electrolyte may be a polymer electrolyte membrane. In certain embodiments, each of the electrolyte-electrode assemblies may be configured as a direct methanol fuel cell. In certain examples, the fuel cell assembly may further comprise a manifold fluidically coupled to at least two of the substantially similar bipolar plates. The manifold may be configured to provide fuel, air or both fuel and air to the bipolar plates. An illustrative fuel cell assembly 800 is shown in FIG. 8. A first fuel cell assembly 880 comprises four bipolar plates 825, 826, 827 and 828 and four electrolyte-electrode assemblies 835, 836, 837 and 838. A second fuel cell assembly 890 comprises four bipolar plates 821, 822, 823 and 824 and four electrolyte-electrode assemblies 831, 832, 833 and 834. The manifold 810 comprises an air in aperture 840, a fuel out aperture 850, an air out aperture 860 and a fuel in aperture 870.

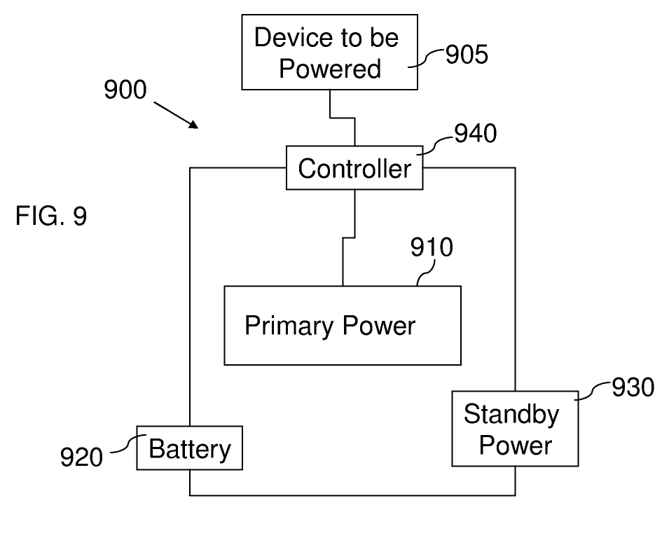

In accordance with certain examples, a power distribution system is provided. In certain examples, the power distribution system includes a primary power source and a standby power source. In some examples, the standby power source may include a fuel cell assembly comprising the bipolar plates disclosed herein. In certain examples, the fuel cell assembly may include a plurality of fuel cell stacks and a plurality of bipolar plates. In some examples, the standby power source may be electrically coupled to a controller that may be configured to detect a power loss. Illustrative controllers are described, for example, in commonly assigned U.S. Pat. No. 7,142,950, the entire disclosure of which is hereby incorporated herein by reference for all purposes. Referring to FIG. 9, an example of a power distribution system is shown. The power distribution system 900 includes a primary power source 910 for powering a device 905, a battery 920, and a standby power source 930 each electrically coupled to a controller 940. The standby power source 930 may be a fuel cell stack or fuel cell assembly as described herein. In normal operation, the controller 940 provides power to the device to be powered 905 using the primary power source 910, which typically is an alternating current source. When the primary power source 910 is functioning properly, the standby power source 930 may be switched off or may be used to charge (or recharge) the battery 920. When the primary power source 910 fails, the controller 940 may send a signal to provide standby power from the standby power source 930 to the device to be powered 905. In certain examples, standby power may be temporarily supplied by the battery 920 until the fuel cell assembly of the standby power source 930 is operating at a sufficient level to provide a desired level of power. In the case where the standby power source 930 is already operating at a desired level, the battery 920 may be omitted or not used to provide power to the device to be powered 905. Alternatively, in the case where standby power is not needed immediately, the battery 920 may be omitted and there may be a delay prior to providing power from the standby power source 930 to the device to be powered 905. In certain examples, the battery 920 may be replaced with super capacitors or a generator, e.g., a diesel-powered or a natural-gas powered generator, which may provide temporary power until the fuel cell assembly 930 is running at a suitable level. Additional configurations and uses of a standby power source will be readily selected by the person of ordinary skill in the art, given the benefit of this disclosure.

In accordance with certain examples, a bipolar plate is provided. In certain examples, the bipolar plate may include a similar arrangement of apertures on both sides, e.g., a dual side bipolar plate. By providing the bipolar plate as a single type, assembly of fuel cell stacks and fuel cell assemblies may be simplified. In certain examples, the first and second bipolar plates are adjacent to each other in the assembled fuel cell assembly. In one embodiment, each of the bipolar plates in a fuel cell assembly may comprise a plurality of apertures. In some examples, the bipolar plate may further comprise a gasket, such as those disclosed herein. Additional features for including in a dual side bipolar plate will be readily selected by the person of ordinary skill in the art, given the benefit of this disclosure.

In accordance with certain examples, a method of assembling a fuel cell stack is provided. In certain examples, the method may comprise assembling the fuel cell stack by placing an electrolyte-electrode assembly between a first bipolar plate and a second bipolar plate. In some examples, the first and second bipolar plates are each a bipolar plate as discussed herein, e.g., the first and second bipolar plates may be constructed and arranged to be similar and to provide a cathodic flow field in the first bipolar plate that is in a substantially similar direction to a cathodic field flow in the second bipolar plate during operation of the fuel cell stack. In some examples, a gasket may be placed between the bipolar plates and the fuel cell stack. For examples, a first gasket may be placed between the first bipolar plate and the electrolyte-electrode assembly and a second gasket may be placed between the second bipolar plate and the electrolyte-electrode assembly. In some examples, the fuel cell stack may be configured as any of the illustrative fuel cell stacks disclosed herein, e.g., a direct methanol fuel cell stack.

In accordance with certain examples, a method of operating a fuel cell stack is provided. In certain examples, the method comprises generating a current by providing air and fuel to the fuel cell stack using two bipolar plates aligned substantially opposite to each other and constructed and arranged to have flow fields in a substantially similar direction. In accordance with certain examples, a method of facilitating assembly of a fuel cell stack is provided. In certain examples, the method comprises providing two similar bipolar plates to assemble the fuel cell stack. In some examples, the method may further comprise providing two similar gaskets for use with the substantially similar bipolar plates. In additional examples, the method may further comprise providing an electrolyte-electrode assembly. In certain examples, the electrolyte-electrode assembly may comprise a polymer electrolyte membrane as the electrolyte.

When introducing elements of the examples disclosed herein, the articles “a, “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

What is claimed is:

1. A fuel cell assembly comprising:
a first bipolar plate;
a second bipolar plate similar to the first bipolar plate and aligned substantially opposite to the first bipolar plate, the second bipolar plate comprising a cathodic flow field in a substantially similar direction to a cathodic flow field of the first bipolar plate;
at least one manifold fluidically coupled to the first and second bipolar plates and configured to provide reactants to the first and second bipolar plates; and
at least one electrolyte-electrode assembly between the first bipolar plate and the second bipolar plate.

2. The fuel cell of claim 1, further comprising a first gasket between the first bipolar plate and the electrolyte-electrode assembly and a second gasket between the second bipolar plate and the electrolyte-electrode assembly.

3. The fuel cell of claim 2, in which the first gasket and the second gasket are similar.

4. The fuel cell of claim 1, in which the first bipolar plate and the second bipolar plate are constructed and arranged to have a similar aperture arrangement.

5. The fuel cell of claim 1, in which the electrolyte-electrode assembly comprises a polymer electrolyte membrane between an anode and a cathode.

6. The fuel cell of claim 5, in which the first bipolar plate, the second bipolar plate and the electrolyte-electrode assembly are constructed and arranged to provide a direct methanol fuel cell.

7. The fuel cell of claim 1, in which the first bipolar plate comprises a plurality of apertures and the second bipolar plates comprises a plurality of apertures, and in which a first aperture in the first bipolar plate is aligned substantially opposite to a first aperture in the second bipolar plate.

8. The fuel cell of claim 1, further comprising at least one additional manifold fluidically coupled to the first bipolar plate and the second bipolar plate.

9. A fuel cell assembly comprising a plurality of a similar bipolar plates and plurality of electrolyte-electrode assemblies, in which at least one of the electrolyte-electrode assemblies is between two of the plurality of the similar bipolar plates, in which each of the electrolyte-electrode assemblies comprises a cathode, an anode and an electrolyte between the cathode and the anode, and in which adjacent bipolar plates are constructed and arranged to be aligned substantially opposite to each other to provide cathodic flow fields having substantially similar directions.

10. The fuel cell assembly of claim 9, in which each of the bipolar plates comprises an anterior cathodic flow field, a posterior anodic flow field and a plurality of apertures to fluidically couple the anterior cathodic flow field and the posterior anodic flow field.

11. The fuel cell assembly of claim 9, in which the electrolyte is a polymer electrolyte membrane.

12. The fuel cell assembly of claim 11, in which each of the electrolyte-electrode assemblies is configured to provide a direct methanol fuel cell.

13. The fuel cell assembly of claim 9, further comprising a manifold fluidically coupled to at least two of the plurality of similar bipolar plates, the manifold configured to provide fuel, air or both fuel and air to the bipolar plates.

14. A power distribution system for a load comprising:
a fuel cell assembly comprising
a fuel cell stack;
at least two adjacent bipolar plates coupled to the fuel cell stack, the two bipolar plates constructed and arranged to provide cathodic field flows having a substantially similar direction; and
a controller electrically coupled to the fuel cell assembly and configured to selectively couple the fuel cell assembly to the load.

15. The power distribution system of claim 14, further comprising at least one battery electrically coupled to the controller.

16. The power distribution system of claim 15, in which the controller is configured to switch the fuel cell assembly on when a power loss is detected by the controller.

17. A method of assembling a fuel cell stack comprising assembling the fuel cell stack by placing an electrolyte-electrode assembly between a first bipolar plate and a second bipolar plate, the first and second bipolar plates constructed and arranged to be similar and to provide a flow field in the first bipolar plate that is in a substantially similar direction to a flow field in the second bipolar plate during operation of the fuel cell stack.

18. The method of claim 17, further comprising assembling the fuel cell stack by placing a first gasket between the first bipolar plate and the electrolyte-electrode assembly and placing a second gasket between the second bipolar plate and the electrolyte-electrode assembly.

19. The method of claim 18, further comprising configuring the fuel cell stack as a direct methanol fuel cell stack.

20. The method of claim 19, further comprising providing air to the first bipolar plate and fuel to the second bipolar plate without using openings in a side of the first and second bipolar plates.

21. A fuel cell assembly comprising
a first bipolar plate comprising a cathodic flow field and an anodic flow field; and
a second bipolar plate fluidically coupled to the first bipolar plate and comprising a cathodic flow field and an anodic flow field, the cathodic flow field of the second bipolar plate being in a substantially similar direction to a direction of the cathodic flow field of the first bipolar plate.
